(19) United States
(12) Patent Application Publication
(10) Pub. No.: US 2001/0054082 A1
(43) Pub. Date: Dec. 20, 2001

(54) CONTROLLED REMOTE PRODUCT INTERNET ACCESS AND DISTRIBUTION

(76) Inventors: Richard F. Rudolph, Loveland, OH (US); Deena Y. Brooks, Germantown, TN (US)

Correspondence Address: Gibbons, Del Deo, Dolan,, Griffinger & Vecchione, One Riverfront Plaza, Newark, NJ, 07102-5497, US

(21) Appl. No.: 09/809,732

(22) Filed: Mar. 15, 2001

Related U.S. Application Data
(60) Provisional application No. 60/189,595, filed on Mar. 15, 2000.

(51) Int. Cl. G06F 15/16

(52) U.S. Cl. 709/217

(57) ABSTRACT

### Abstract of Disclosure

A system for accessing a remote computer network. The system comprising (a) a package; (b) an identification tag coupled to the package that stores identifying data unique to the package; (c) an interrogator located external to the package; and (d) a computer system coupled to the interrogator for exchanging information with a remote site. The interrogator transmits a query to the identification tag and the identification tag responds by communicating the identifying data to the computer system, thereby accessing the remote computer network.

### Cross Reference to Related Applications

This application claims priority from U.S. Provisional Application No. 60/189,595 which was filed on March 15, 2000 and is incorporated by reference.

### Background of the Invention

### Field of the Invention

This invention relates to the field of packaging, and more particularly to a package interfacing to a computer system.

### Description of the Related Art

Promotional items have long been associated with products, being obtained through submitting coupons, distributed during check out, or attached to the package directly. Coupons, promotional product distribution, and package bundling all require extensive handling and overhead. Promotional items result in duplication to a frequent buyer of a product, or are simply ignored.

There is a need to be able to distribute promotional items with reduced overhead. There is a further need to be able to provide promotional items, which reduce duplication.

Manufacturers and suppliers frequently have additional information of value to a purchaser or may require an exchange with or receipt of data from a purchaser, such as warranty or safety information.

### Summary of Invention

The present invention is a system for accessing a remote computer network. The system comprising (a) a package; (b) an identification tag coupled to the package that stores identifying data unique to the package; (c) an interrogator located external to the package; and (d) a computer system coupled to the interrogator for exchanging information with a remote site. The interrogator transmits a query to the identification tag and the identification tag responds by communicating the identifying data to the computer system, thereby accessing the remote computer network.

The present invention includes a method for accessing a remote computer network, which comprises the steps of: (i) providing an integrated system comprising, (a) a package, (b) an identification tag coupled to the package that stores identifying data unique to the package; (c) an interrogator located external to the package, and (d) a computer system coupled to the interrogator for exchanging information with a remote site; (ii) sending a query signal from the interrogator to the identification tag; (iii) responding to the query signal by communicating the identifying data from the identification tag to the computer system; (iv) executing a script associated with the identifying data in the computer system; and, (v) instructing the computer system to access the remote computer network, wherein the script contains programmed instructions.

### Brief Description of Drawings

A more complete understanding of the present invention may be obtained from consideration of the following description in conjunction with the drawings in which:

FIG. 1 is a functional overview of a system employing the present invention.

### Detailed Description

The present invention accesses a remote computer network through a package which has identifying information associated with it. The remote computer network provides the user with product related information in the form of advertising, promotions, product specifications, warranties, and the like. The system comprises (a) a package; (b) an identification tag coupled to the package that stores identifying data unique to the package; (c) an interrogator located external to the package; and (d) a computer system coupled to the interrogator. The interrogator transmits a query to the identification tag and the identification tag responds by communicating the identifying data to the computer system, thereby accessing the remote computer network.

The package may be any material or structure that holds a product or data. For example paper, cardboard, plastic, wood, metal, and the like may be used.

The identification tag may be, for example, a bar code, a radio frequency identification (RFID) tag, data recorded magnetically, or any suitable identifying device.

The identifying data carried by the identification tag comprises information such as, product identification, serial number, activation codes for executing a script file, a URL or other reference to a web site, or any similar type of information.

The identifying data is retrieved by an interrogator, which transmits a query to the identification tag. The identification tag responds to the query by communicating the identifying data. Thus the interrogator selected for use in the present invention is capable of communicating with the identification tag. Suitable interrogators include, but are not limited to laser scanners, RFID readers, and the like, depending on the particular identification tag employed.

In one embodiment, bar codes are employed as at least a portion of the identification tag. They are graphical representations of information encoded within a series of bars and spaces. Some bar code symbologies, such as UPC-A, have a specific bar code pattern for each character based upon the location of that character within the bar code. For example, a number 3 in the first part of the bar code is encoded differently than a number 3 in the second half of the bar code. Still other symbologies encode data in pairs and are dependent upon the preceding or following characters as to which pattern is used.

All bar codes have certain bar code patterns which tell the reading device when to start reading the bar code and when to stop reading. PrintBar III automatically adds all Start and Stop characters within the bar code. In some bar code symbologies, an option is provided to either print or not print the Human Readable portion of these characters. Human Readables are the alphabetic and numeric characters for the data encoded within the bar code. When used, Human Readable (HR) characters may be printed below or above the bar code. Check Digits mathematically calculated values which help the reading device determine if the bar code was read correctly. Check digit characters are usually added to the end of the bar code. Some symbologies, such as Code 39, do not need check digit characters as they are designed to be self checking. Other symbologies, such as UPC-A, require check digits be added. Supplements are a separate, shorter bar code that can be optionally added to the end of certain symbologies such as UPC, EAN and JAN to encode prices, dates, etc. When used, Human Readable characters are always printed above the supplement.

2-Dimensional bar codes enable more information to be encoded in a smaller space than a traditional 1-dimensional bar code. Essentially there are two types of 2-dimensional bar codes currently in use: stacked codes; and, matrix codes.

Stacked symbology, evolved from 1-dimensional bar codes, such as Code 39 and Code 128 symbologies, which are stacked in horizontal layers to create a multirow symbologies, Code 49 and Code 16K respectively.

Matrix Symbologies, which are scaleable, provide higher data densities than stacked codes in most cases, as well as are orientation independent. A matrix code is comprised of a pattern of cells which can be square, hexagonal or circular in shape. Data is encoded into the matrix through the relative positions of the light and dark areas. Encoding schemes can utilize error detection and correction techniques for improved reading reliability, including enabling the reading of partially damaged symbols.

Composite bar codes is a class of symbology in which two symbols are printed in close proximity to each other and contain linked data. Typically, one component is a linear bar code symbol and the other component is a multi-row or matrix bar code symbol. The composite bar code enables different information to be available to different applications during an items" life cycle. A typical use of a composite bar code is in the pharmaceutical industry where both product identification and supplementary information, such as expiration date and batch number, are encoded in a small area for access in different applications during the product life cycle. The UCC.EAN composite symbol standard includes EAN-13 or UPC-A or UCC.EAN 128 symbols, as well as the RSS (reduced space symbologies) together with a two-dimensional multirow symbol.

An interrogator for bar codes comprises a bar code scanner, which typically utilizes CCD or laser technology, either hand held or fixed mount. Such scanners essentially contain a means for illuminating the bar code symbol and a means for measuring the reflected light. The reflected light data is converted into a digital signal, which can then be decoded. A typical CCD scanner utilizes a flood of light, such as an LED light source, to illuminate the bar code symbol, which is reflected back to an array of photosensors. A laser scanner typically utilizes a laser beam, having a source such as a laser diode, which is spread into a horizontal arc by a rapidly moving mirror. More sophisticated scanning patterns including a moving-beam raster, cross-hatched, or starburst pattern can provide improved readability and omni-directional scanning.

In a preferred embodiment, the identification tag comprises a radio frequency identification (RFID) tag. RFID tags come in a wide variety of shapes and sizes. RFID tags maybe categorized as either active or passive. Active RFID tags may be powered by an internal battery and are typically read/write, i.e., tag data can be rewritten and/or modified. An active tag memory size varies according to application requirements. Some systems operate, for example with up to 1MB of memory. In a typical read/write RFID system, a tag can provide a set of instructions or information, and the tag can receive encoded information. This encoded data then becomes part of the history of the tagged product. The battery-supplied power of an active tag generally gives it a longer read range. The trade off is greater size, greater cost, and a limited operational life.

Passive RFID tags operate without a separate external power source and obtain operating power generated from the reader. Passive tags consequently are usually lighter in weight than active tags, less expensive, and offer a virtually unlimited operational lifetime. The trade off is that passive tags have shorter read ranges than active tags and require a higher-powered reader.

Read-only tags are typically passive and are programmed with a unique set of data (usually 32 to 128 bits) that cannot be modified. Read-only tags may operate as a key or index into a database, in the same way as linear barcodes reference a database containing modifiable product-specific information.

When a RFID tag is used, an antenna is included in the system of the present invention. The antenna receives and transfers radio signals to activate the tag and to read and write data to the tag. Antenna may be a variety of shapes and sizes. For example, an antenna can be built into a doorway to receive tag data from persons or things passing through the door. An electromagnetic field produced by an antenna can be constantly present when multiple tags are expected continually. If constant interrogation is not required, a sensor device can activate the field.

An antenna may be configured with the transceiver/decoder to become part of the reader or interrogator, which can be configured either as a handheld or a fixed-mount device. The reader emits radio waves across distances of anywhere from one inch to 100 feet or more, depending upon the signal power output and the radio frequency used. When an RFID tag passes through an electromagnetic sensing zone, the tag responds to the activation signal of the reader and causes an associated antenna to emit radio waves. The reader decodes the data encoded in a memory portion of an integrated circuit of the tag. The data is passed to a host computer for processing.

Frequency ranges also distinguish RFID systems. Low-frequency (30 kHz to 500 kHz) systems typically have short reading ranges and lower system costs. They are most commonly used in security access, asset tracking, and identification applications. High-frequency (850 mHz to 950 mHz and 2.4 gHz to 2.5 gHz) systems typically offer long read ranges (greater than 90 feet) and high reading speeds.

A significant advantage of RFID systems is the non-contact, non-line-of-sight nature of the technology. Tags can be read through a variety of substances such as snow, fog, ice, paint, crusted grime, and other visually and environmentally challenging conditions, where barcodes or other optical read technologies are problematic. RFID tags can also be read in challenging circumstances at high speeds, typically responding in less than 100 milliseconds.

The range that can be achieved with an RFID system is determined essentially by: power available at the reader/interrogator to communicate with the tag(s), power associated with the tag to respond, and environmental conditions and structure, the former being more significant at higher frequencies, including signal to noise ratio.

Although the level of available power is a primary determinant of range, the manner and efficiency with which that power is employed also influences the range. The field or wave delivered from an antenna extends into the space adjacent the antenna and its strength diminishes with respect to distance. Antenna design will determine the shape of the field or propagation wave delivered, so that range will also be influenced by the angle subtended between the tag and antenna.

In space free of any obstructions or absorption mechanisms, the strength of a field declines in inverse proportion to the square of the distance between transmitter and receiver. For a wave propagating through a region in which reflections can arise from the ground and from obstacles, the reduction in signal strength can vary quite considerably. In some cases, signal strength may vary as an inverse fourth power of the distance between transmitter and receiver. Where different propagation paths arise, the phenomenon is known as multi-path attenuation. At higher frequencies, absorption due to the presence of moisture can further influence range. It is therefore important in many applications to determine how the environment, internal or external, can influence the range of communication. Where a number of reflective metal "obstacles" are to encountered within the application to be considered, and can vary in number from time to time, it may also be necessary to establish the implications of such changes through an appropriate environmental evaluation.

The identifying data that is communicated from the identification tag is sent to a computer system, which is capable of processing the identifying data and executing instructions derived from the data. For example, the identifying data may provide the computer system with a product identification number, which instructs the computer system to execute a script file containing a set of instructions. Depending on the instructions, the computer system will link or access a remote computer system.

The present invention also includes a method for accessing a remote computer network. The method comprises the steps of: (i) providing an integrated system comprising, (a) a package, (b) an identification tag coupled to the package that stores identifying data unique to the package; (c) an interrogator located external to the package, and (d) a computer system coupled to the interrogator for exchanging information with a remote site, (ii) sending a query signal from the interrogator to the identification tag; (iii) responding to the query signal by communicating the identifying data from the identification tag to the computer system; (iv) executing a script associated with the identifying data in the computer system; and, (v) instructing the computer system to access the remote computer network, wherein the script contains programmed instructions.

Although the present invention is particularly well suited for promotional product distribution, and shall be so described, the present invention is equally well suited for use in controlled product distribution, progressive product distribution, warranty registration, service, and product updates.

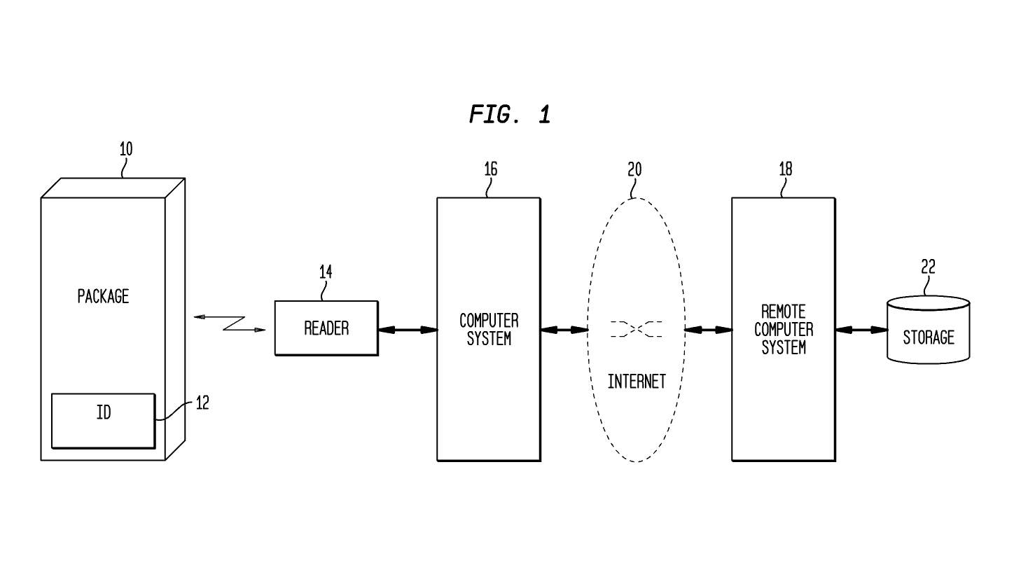

Referring to FIG. 1 there can be seen a functional overview of a system employing the present invention. A package 10 contains an identification tag 12. The identification tag 12 may be a linear bar code, composite bar code, 2-dimensional bar code, RFID or other suitable identification tag 12. The identification tag 12 contains encoded data corresponding to a unique product identification, serial number, and URL or other reference to a Web site. Optionally, the identification tag 12 can contain a script (a set of commands) to be executed by the web site, or may reference a file or an index, which corresponds to a script.

A reader 14 interrogates the identification tag 12. The interrogator 14 is coupled to a computer system 16. A remote computer network 18 is accessed by the computer system 16 over the Internet 20 to establish a link. The link may be established with a conventional Web browser utilizing a plug in to interface to the reader 14. Alternatively, the link can be established through a client application, including a thin client running in the background of the computer system 16. The Web site is identified for example by a URL, which may be contained in the encoded data.

When a link has been established to the Web site identified by the URL, the unique product identification and optional serial number are transferred to the remote computer network 18. The remote computer 18 or the web browser at the computer system 16 can then execute a script, such as that identified in or contained in the encoded data. The web browser would then display a suitable welcome screen from computer storage 22 and identify the package 10. The link could then provide information about the product, including user guides, supply sales, warranty, servicing, and other information of interest to the consumer or end user. Consumer or end user information stored in the form of a cookie is then linked to the remote computer 18. The cookie may be stored by the web browser at the computer system, from operating system stored information, or through a user sign-on that then stores a cookie. By completing a questionnaire, a first time user creates a cookie that contains consumer/end user information, which can be used for product registration.

Package 10 can then be used to distribute a promotional item. For example, promotional items could be mailed or shipped to the consumer based upon information obtained from the consumer. In a preferred embodiment, the promotional item is in digital form, which can be directly distributed to the consumer through the link established between the computer system 16 and the remote computer network 18. Suitable digital items include screen savers, fonts, computer games, textual material, music (such as M-PEG3) and video content. The present invention is not limited to promotional product distribution, but can be used for direct consumer product distribution, where the consumer obtains a package 10 containing the identification tag 12. The package 10 can be prepaid at a local retail store, mailed or distributed free and then payment is completed through an e-commerce solution.

Progressive sequence products can be distributed, where a consumer gets another feature or level in software such as a computer game when the consumer acquires another package 10, or a different package 10. The remote computer network 18 keeps an accounting of consumer purchases for which promotional items are distributed and identities of particular consumers. Using a user sign-in and password, along with information contained on a local file, such as a cookie, the identity of a consumer may be authenticated, thus reducing fraudulent promotional/product distribution. Progressive rewards can be offered, serving to promote brand and product loyalty. With a product such as a computer game/video game, individual user activity can be tied into distribution of personalized features.

When the package 10 is associated with an expensive luxury item, such as jewelry, watches, etc., the manufacturer can authenticate the product. By accessing the serial no. in the encoded data along with the consumer information, automatic product registration, warranty and service, can be accomplished and encouraged.

In view of the foregoing description, numerous modifications and alternative embodiments of the invention will be apparent to those skilled in the art. A customer interface agent may be a thin agent with minimal functionality or may be enhanced to provide developmental resources and assistance to the customer, including use of an intelligent agent to provide assistance. Accordingly, this description is to be construed as illustrative only and is for the purpose of teaching those skilled in the art the best mode of carrying out the invention. Details of the structure may be varied substantially without departing from the invention.

Claims

1. A system for accessing a remote computer network, comprising:
a package;
an identification tag coupled to said package that stores identifying data unique to said package;
an interrogator located external to said package;
a computer system coupled to said interrogator for exchanging information with a remote site;
wherein said interrogator transmits a query to said identification tag and said identification tag responds by communicating said identifying data to said computer system, thereby accessing said remote computer network.

2. The system of claim 1, wherein said identification tag is selected from the group consisting of: a linear bar code, a composite bar code, a 2-dimensional bar code, a radio frequency identification transponder, and data recorded magnetically.

3. The system of claim 1, wherein said identifying data further comprises data selected from the group consisting of: a product identifier, a serial number, a URL or other reference to a web site, and combinations thereof.

4. A method for accessing a remote computer network, which comprises the steps of:
(i) providing an integrated system comprising,
a package,
an identification tag coupled to said package that stores identifying data unique to said package,
an interrogator located external to said package, and
a computer system coupled to said interrogator for exchanging information with a remote site,
(ii) sending a query signal from said interrogator to said identification tag;
(iii) responding to said query signal by communicating said identifying data from said identification tag to said computer system;
(iv) executing a script associated with said identifying data in said computer system; and,
(v) instructing said computer system to access said remote computer network,
wherein said script contains programmed instructions.

5. The method of claim 4, wherein said identification tag is selected from the group consisting of: a linear bar code, a composite bar code, a 2-dimensional bar code, a radio frequency identification transponder, and data recorded magnetically.

6. The method of claim 4, wherein said identifying data is selected from the group consisting of: a product identifier, a serial number, a user identifier, a URL or other reference to a web site, and combinations thereof.

7. A method for providing product materials by accessing a remote computer network, comprising the steps of:
(i) providing an integrated system comprising,
a package,
an identification tag coupled to said package that stores identifying data unique to said package,
an interrogator located external to said package, and
a computer system coupled to said interrogator for exchanging information with a remote site,
(ii) sending a query signal from said interrogator to said identification tag;
(iii) responding to said query signal by communicating said identifying data from said identification tag to said computer system;
(iv) executing a script associated with said identifying data in said computer system,
wherein said script contains programmed instructions;
(v) instructing said computer system to access said remote computer network; and
(vi) sending said product materials from said remote computer network to said computer system.

8. The method of claim 7, wherein said product materials is selected from the group consisting of: product information, instruction manuals, advertising, registration materials, promotional items, and mixtures thereof.

9. The method of claim 8, wherein said promotional items are selected from the group consisting of: screen savers, fonts, computer games, text files, music files, video files, and mixtures thereof.

10. The method of claim 7, wherein said product materials are downloadable.

11. The method of claim 7, wherein said identification tag is selected from the group consisting of: a linear bar code, a composite bar code, a 2-dimensional bar code, a radio frequency identification transponder, and data recorded magnetically.

12. The method of claim 7, wherein said identifying data is selected from the group consisting of: a product identifier, a serial number, a user identifier, a URL or other reference to a web site, and combinations thereof.

13. The method of claim 7, wherein a cookie is used to communicate between said remote computer.
